(19) United States
(12) Patent Application Publication
(10) Pub. No.: US 2014/0116743 A1
(43) Pub. Date: May 1, 2014

(54) Driving System for Cleaning Machine

(71) Applicants: Ludvig Brunnström, Asa (SE); Patrik Andreasson, Barcelona (ES)

(72) Inventors: Ludvig Brunnström, Asa (SE); Patrik Andreasson, Barcelona (ES)

(73) Assignee: QLEENO AB, Gothenburg (SE)

(21) Appl. No.: 14/129,964

(22) PCT Filed: Jun. 26, 2012
(86) PCT No.: PCT/SE2012/050714

§ 371 Date: Dec. 28, 2013

(30) Foreign Application Priority Data
Jun. 28, 2011 (SE) 1100499-1

(51) Int. Cl. B25F 5/00

(52) U.S. Cl. CPC B25F 5/00
USPC 173/217

(57) ABSTRACT

The invention relates to a driving system (6) for a cleaning machine (1), which comprises a floor treating brush and/or disc (7) rotatably driven by a motor (4) and exhibiting surrounding ring-shaped rim and vacuum duct (10) for suction (13) of washing liquid (14). According to the invention the motor is formed by a horizontally arranged, electrically driven hub motor (4). The rotor (15) of the motor (4) is drivably connected to said rotatably driven floor treating brush and/or disc (7), while the stator (17) of the motor (4) is connected to the stationary frame (18) of the cleaning machine (1).

The present invention relates to a driving system for cleaning machine, which comprises a floor treating brush and/or disc rotatably driven by a motor and exhibiting a surrounding ring-shaped rim and conduit for washing liquid and vacuum suction duct for the supply of washing liquid and suction of washing liquid, respectively.

Known cleaning machines, in which washing liquid is used, comprise motors, conduits and ducts, which cause that the height of the cleaning machine in question will be considerable. This means that the machine is not so suitable to use when one wishes to reach under low objects, as for example under seats in buses, underground carriages, trains, etc.

Therefore, the main object of the present invention is first of all to provide a driving system of the kind mentioned above, which among other things makes it possible to solve the problem mentioned above in a simple and effective way, but which also solves a number of further problems.

Said object is reached by means of a driving system according to the present invention, which is mainly characterized in that the motor is formed by a horizontally arranged, electrically driven hub motor, that the rotor of the motor is drivably connected to the rotatably driven floor treating brush and/or disc, while the stator of the motor is connected to the stationary frame of the cleaning machine, or vice versa, that the motor surrounds a stationary vertical central shaft, which exhibits an inner vacuum suction duct, and connection for the vacuum suction duct, whereby the central shaft also forms a channel for reception of the electric cables of the motor.

As is clear from the drawings, a separate central axis 19 has the function of including vacuum suction duct 10 as well as channel 22 for reception of electric cables 23.

Thus, a compact and simple solution when constructing a power-driven cleaning machine is obtained.

By SE 529868 C2 known cleaning machine does not comprise any separate central shaft exhibiting said characteristics and functions, but which is formed by several assembled loose parts, which are put together to a functioning vacuum suction duct (22, 18, 23), and with centrally located separate water supply tube (14). Thereby, there are no electric cables, since the motor (9) for operation of the illustrated cleaning machine (1) is located at a large distance from the rotatably driven scrubbing brush (6), and therefore a pulley (19) is required at the hub (18) of the scrubbing brush (6).

By GB 2175797A known cleaning machine does not have any liquid conduits, since the invention described and illustrated in said publication only relates to a motor driven scrubbing brush, which does not have any supply of liquid or liquid suction device, but comprises a horizontally arranged hub driving motor, the parts of which (14, 16) are mounted on the brush (6) and in the frame (13), respectively, with an intermediate homogeneous bearing shaft (8) and a bearing (10).

The invention is described below as a number of preferred embodiments, whereby it is referred to the accompanying drawings, in which

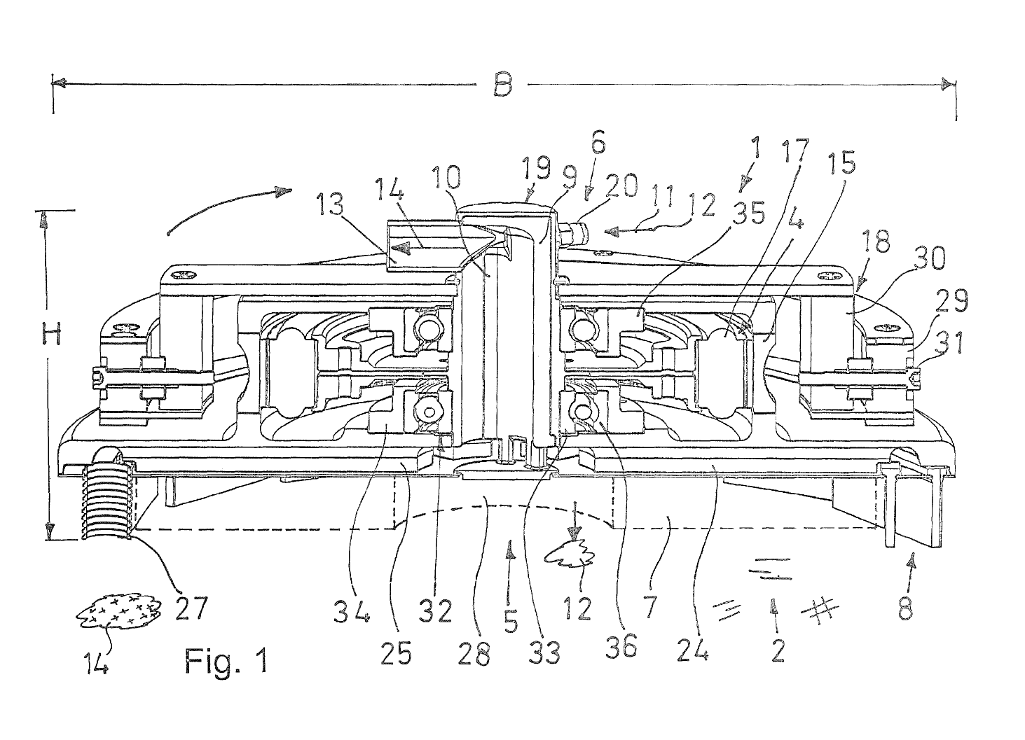

FIG. 1 illustrates in a perspective view a section through a cleaning machine according to the invention, with shown motor,

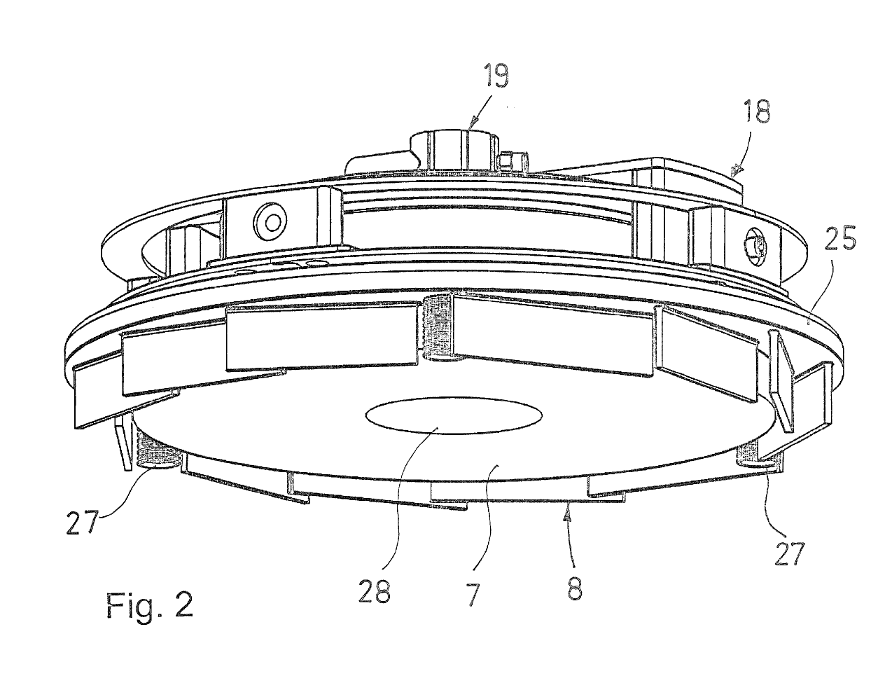

FIG. 2 illustrates a perspective view of the machine seen obliquely from below,

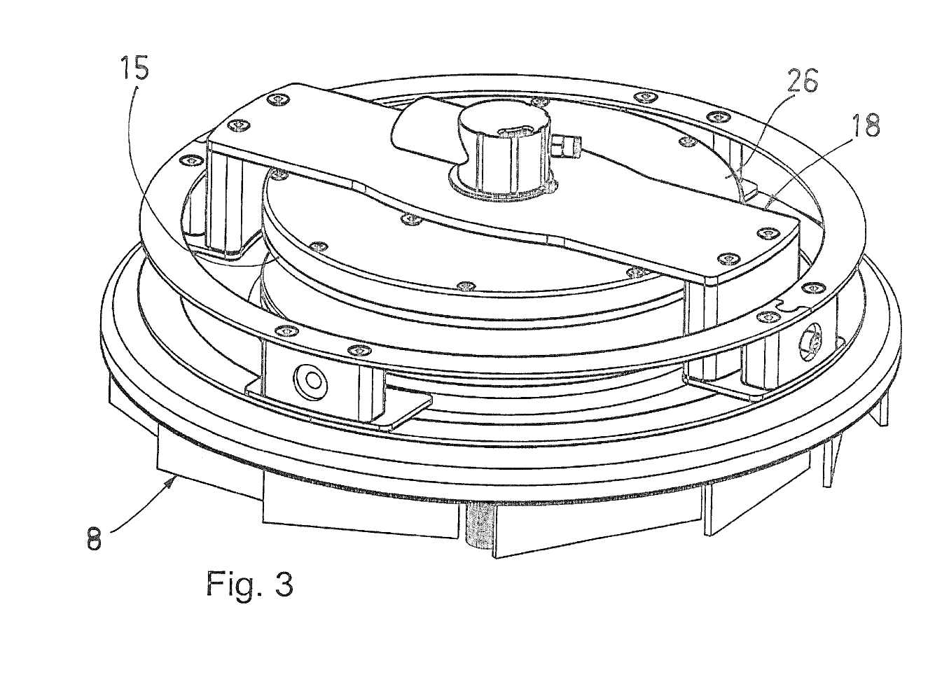

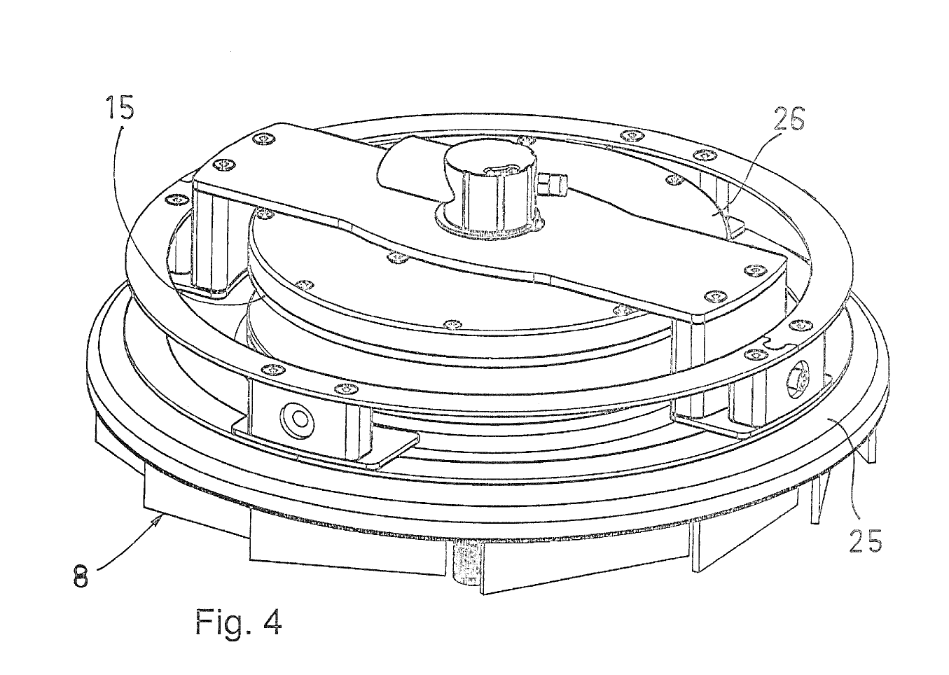

FIGS. 3-4 are perspective views of the machine seen obliquely from above,

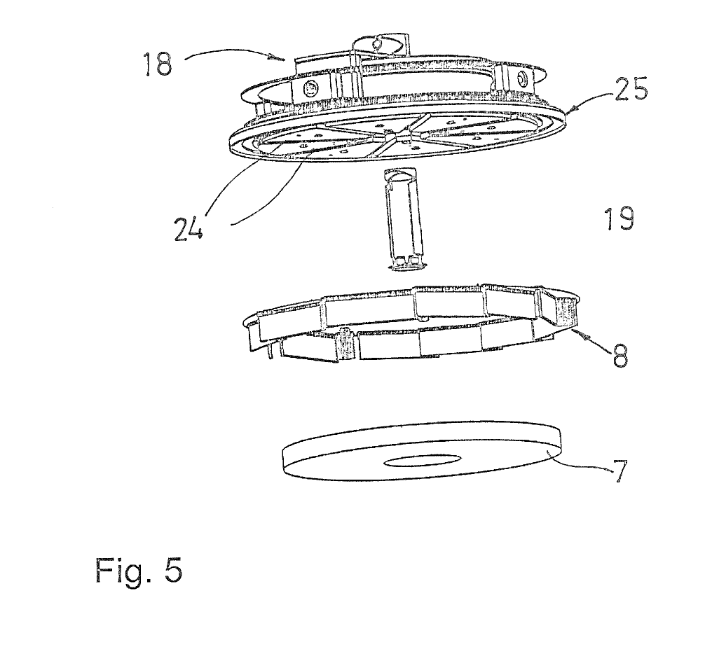

FIG. 5 is a perspective exploded view of the machine and its dismountable parts,

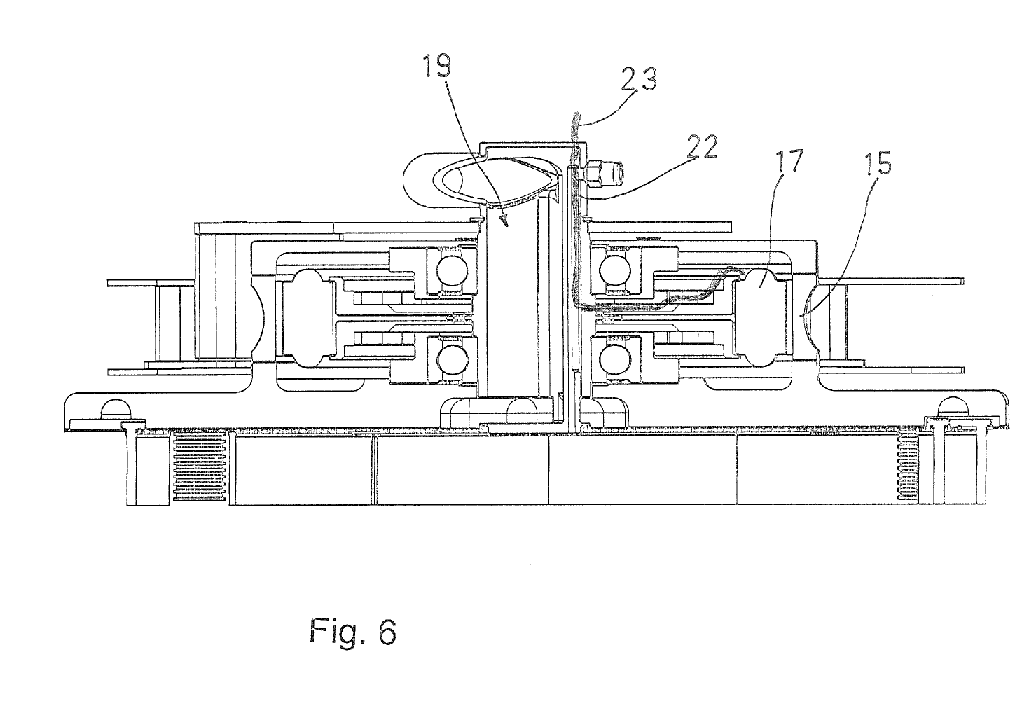

FIG. 6 is a cross-sectional view of the machine, whereby the location of the electric cables is shown,

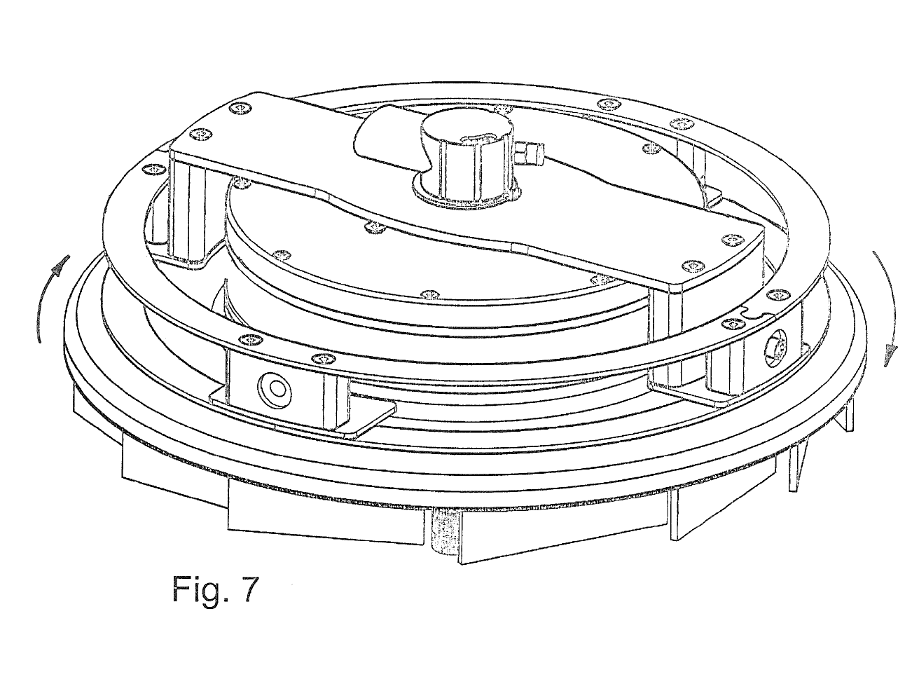

FIG. 7 is a schematic perspective view of the machine obliquely from above,

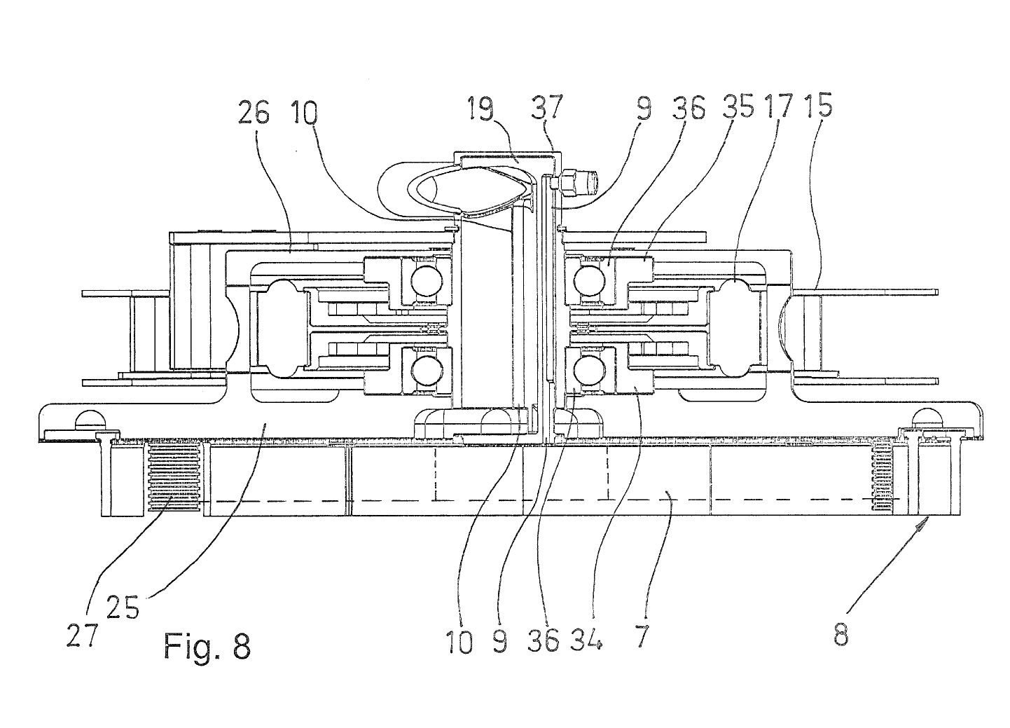

FIG. 8 is a cross sectional view of the machine, and

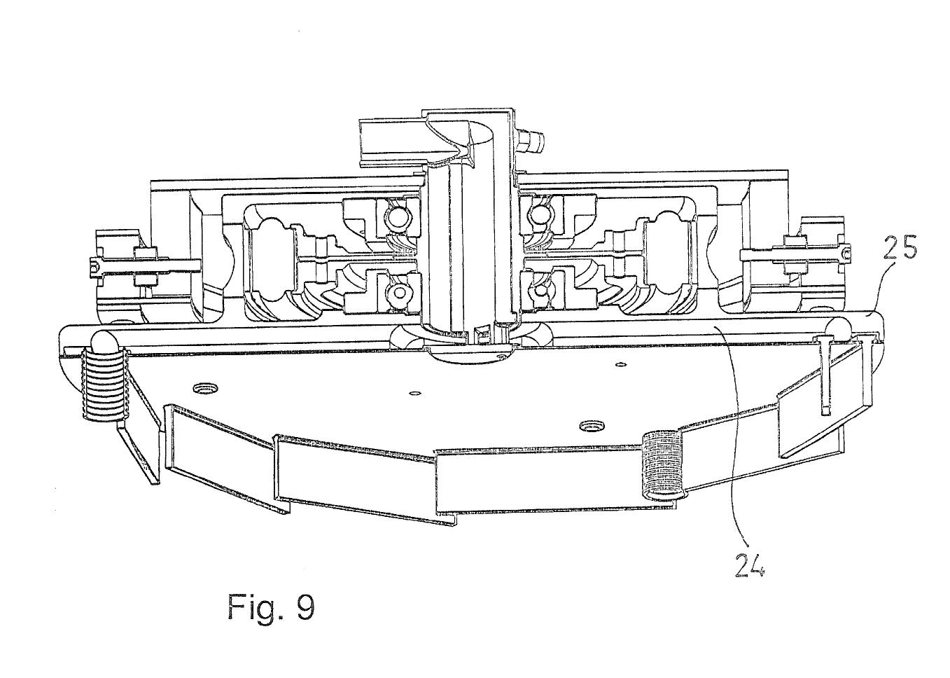

FIG. 9 is a perspective view of the machine seen obliquely from below and in section.

A compact cleaning machine 1 illustrated in the drawings is normally arranged and adapted to be surrounded by a not shown frame with wheels and handle, and by means of which the operator drives said cleaning machine 1 on the floor 2 or another surface, which one wishes to clean by means of the cleaning machine 1 in question. Thus, only the cleaning portion 3 itself with motor and cleaning parts 5 are shown.

First of all with a view to try to make the cleaning machine 1 as low as possible, so that its active height H does not intrude on low furniture and other low obstructive objects situated at a low height above the floor 2, the driving system 6 has been arranged in a special way.

According to the invention a driving system 6 for a cleaning machine 1 is provided, which machine comprises a floor treating brush and/or cleaning disc 7 rotatably driven by a horizontally arranged, electrically driven hub motor 4, and exhibiting a surrounding rim 8 of elastic material, for example plastic or rubber, and conduit 9 for washing liquid and vacuum suction duct 10 for the supply 11 of clean washing liquid 12 and detergent and suction 13 of dirty washing liquid 14, respectively. Further, the rotor 15 of the motor 4 is drivably connected to said rotatably driven floor treating brush and/or disc 7, while the stator 17 of the motor 4 is connected to the stationary frame 18 of the cleaning machine 1. When the motor 4 is built-in in said cleaning machine 1 it exhibits a substantially larger extension laterally, i.e. in breadth B, than in height H, i.e. horizontally and vertically, respectively, provided that the cleaning machine 1 is kept in normal cleaning position on a substantially horizontal floor or other surface 2. The ratio between breadth and height of the motor may be about 8:1.

The motor 4 surrounds a stationary vertical central shaft 19, which exhibits an internally therein arranged vacuum suction duct 10, and a connection 21 for the vacuum suction duct 10. A protecting cover 37 with connections for said vacuum suction duct 10 surrounds the shaft 19 from above.

Said central shaft 19 also forms channel 22 for reception of the electric cables 23 of the motor, and is connected to said stator 17 of the motor, which exhibits the windings of the motor. The central shaft 19 is connected to the stationary frame 18 of the machine. The rotor 15 is as an integrated part connected to a disc-shaped bottom part 25, which is provided with radial vacuum ducts 24, and a cover 26 covering the motor, and used dirty washing liquid 14 is sucked up via said vacuum suction ducts 24 from suction nozzles 27.

Preferably, said stationary vertical central shaft 19 also surrounds the conduit 9 for washing liquid and exhibits a connection 20 for said conduit 9 for washing liquid. The connection for said connecting conduit 9 for washing liquid also extends through said surrounding protecting cover 37.

Supplied washing liquid 12 reaches the floor 2 from the conduit 9 for washing liquid in the central shaft 19 via a central recess 28 in the cleaning disc 7.

Preferably, gyroscopic mountings 31 are provided between bearing parts 29, 30 of the frame 18, which are arranged to take up the movements of the machine during operation.

Bearings 32 for the machine are connected to said shaft 19 with its inner ring 33 and with bearing holders in the form of surrounding supports 34, 35 for its outer ring 36. Said surrounding supports 34, 35 are connected to the bottom part 25 and to the motor cover 26, respectively.

The function and nature of the invention should have been understood with the aid of the above description.

It is also possible to connect the stator and the rotor of the motor reversely, i.e. that the rotor of the motor is connected to the stationary frame of the machine and the stator of the motor is connected to the rotatably driven floor treating brush and/or disc of the machine.

Of course, the invention is not limited to the embodiments described above and illustrated in the accompanying drawings. Modifications are possible, especially as far as the nature of the different parts is concerned, or by using equivalent technique, without departing from the scope of the invention as it is defined in the patent claims.

1-10. (canceled)

11. A driving system for a cleaning machine having a floor-treating brush or disk, a surrounding ring-shaped rim, a conduit for supplying washing liquid, and a vacuum suction duct for collecting dirty washing liquid, comprising:
an electrically driven hub motor that is horizontally arranged and that is configured for rotatably driving the floor-treating brush or disk;
wherein a rotor of the hub motor is drivably connected to the floor-treating brush or disk, a stator of the hub motor is connected to a stationary frame of the cleaning machine, the hub motor surrounds a stationary vertical central shaft, the vacuum suction duct and a connection to the vacuum suction duct are disposed internally in the stationary vertical shaft, and the central shaft also includes a channel for reception of an electric cable of the hub motor.

12. The system of claim 11, wherein a lateral extent of the hub motor is substantially larger than a vertical extent of the hub motor.

13. The system of claim 12, wherein a ratio between a breadth and a height of the cleaning machine is about 8:1.

14. The system of claim 11, wherein the stationary vertical central shaft includes an inner conduit for washing liquid and a connection to the inner conduit for washing liquid.

15. The system of claim 11, wherein the stationary vertical central shaft is connected to the stationary frame.

16. The system of claim 11, further comprising a motor cover that covers the hub motor, wherein the rotor is connected as an integrated part to a disk-shaped bottom part having radial vacuum ducts.

17. The system of claim 16, wherein bearings of the hub motor are received by respective supports connected respectively to the bottom part and to the motor cover.

18. The system of claim 11, further comprising a protecting cover having a connection to the vacuum suction duct and surrounding an upper portion of the central shaft.

19. The system of claim 11, wherein dirty washing liquid is collected via the vacuum suction duct from a suction nozzle.

20. The system of claim 11, wherein the central shaft is connected to the stator, which includes windings of the hub motor.
